(19) United States
(12) Patent Application Publication
(10) Pub. No.: US 2006/0206042 A1
(43) Pub. Date: Sep. 14, 2006

(54) Transmission shaft of a massager

(76) Inventor: Peter Chen, Taipei (TW)

Correspondence Address: BACON & THOMAS, PLLC, 625 SLATERS LANE, FOURTH FLOOR, ALEXANDRIA, VA, 22314, US

(21) Appl. No.: 11/075,698

(22) Filed: Mar. 10, 2005

(51) Int. Cl. A61H 7/00

(52) U.S. Cl. 601/99; 601/101; 601/103

(57) ABSTRACT

A transmission shaft includes a hollow cylindrical casing with two open ends and a cutout defined through an outer periphery of the cylindrical casing, a stationary arm a proximate end thereof is integrally formed with the cylindrical casing and a distal end thereof is for connection with one of the two sticks, a rotation arm a proximate end thereof is rotatably received in the cylindrical casing and a distal end thereof is for connection with the other one of the two sticks and a pin movably received in the cutout and securely extended into a periphery of the proximate end of the rotation arm. The pin is reciprocal movable from a first position to a second position when the motor rotational direction changes such that the two sticks are able to change from providing kneading effect to providing pounding effect.

### BACKGROUND OF THE INVENTION

1. Field of the Invention

The present invention relates to a transmission shaft, and more particularly to a transmission shaft of a massager enabling the massager to switch from kneading to pounding and vice versa.

2. Description of Related Art

In general, a massager is able to applying kneading and pounding to a user in need. To meet the requirement, the available massager in the market has a kneading transmission shaft and a pounding transmission shaft to work independently via a motor. Due to the two different transmission shafts, the existing massager is big is dimension and has complex structure. As a result, the cost thereof is high and can not be afforded by average people.

To overcome the shortcomings, the present invention tends to provide an improved transmission shaft to mitigate the aforementioned problems.

### SUMMARY OF THE INVENTION

The primary objective of the present invention is to provide a transmission shaft to enable the massager to change from kneading to pounding and vice versa.

In one aspect of the present invention, the transmission shaft of the present invention has a stationary arm affixed to a hollow cylindrical casing, a rotation arm rotatably received in the cylindrical casing and provided with a pin extending into the rotation arm and received in a cutout which is defined in an outer periphery of the transmission shaft such that in a situation where the casing is rotated in a first rotation and the pin is abutted against a first dead point in the cutout, the massager is able to provide a kneading effect and in a situation where the casing is rotated in a second rotation opposite to the first direction, a phase difference is existed between the stationary arm and the rotation arm due to the movement of the pin form the first dead point to a second dead point. As a result, with only one transmission shaft, the massager is able to change from kneading to pounding and vice versa.

In yet another aspect of the present invention, a respective free end of the stationary arm and the rotation arm is connected to a sleeve having an inclined face formed on an end of the sleeve and having an extension which is formed on a bottom of the inclined face for connection to a massaging stick. Therefore, the two sticks are able to provide kneading and/or pounding effect alternately when the motor changes its rotation direction.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a massager;

FIG. 2 is an exploded perspective view of the transmission shaft of the present invention;

FIG. 3 is a schematic view with partial in cross section showing that the massaging stick is providing a kneading effect due to the rotation of the motor;

FIG. 4 is a schematic top plan view with partial in cross section showing that the pin is at a first dead point in the cutout;

FIG. 4A is a schematic side plan view with partial in cross section showing that the motor is rotated in the first direction to place the pin in the first dead point;

FIG. 5 is a schematic top plan view with partial in cross section showing that the pin is moving from the first dead point toward a second dead point;

FIG. 6 is a schematic top plan view with partial in cross section showing that the pin is at the second dead point; and

FIG. 6A is a schematic side plan view with partial in cross section showing that the pin is at the second dead point with the motor's rotational direction toward the second direction.

### DETAILED DESCRIPTION OF THE PREFERRED EMBODIMENT

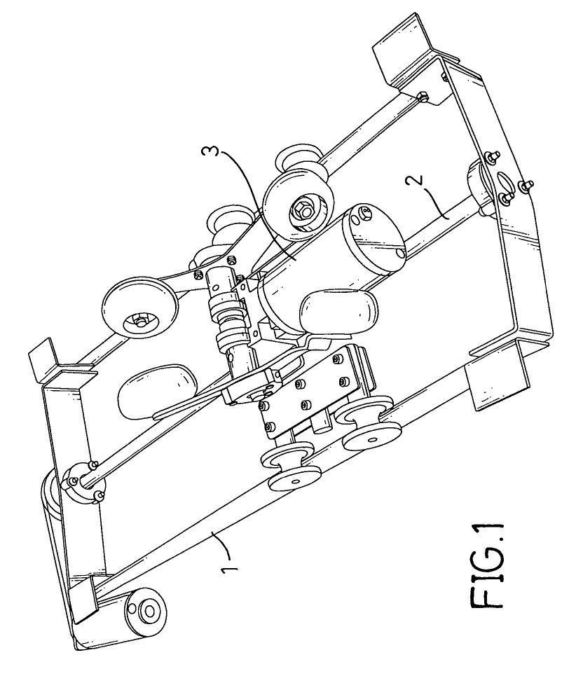

With reference to FIG. 1, it is noted that a general massager includes a frame (1), a transmission axle (2) connecting two opposite sides of the frame (1) and a motor (3) mounted on top of the transmission axle (2) to drive the transmission axle (2) to rotate.

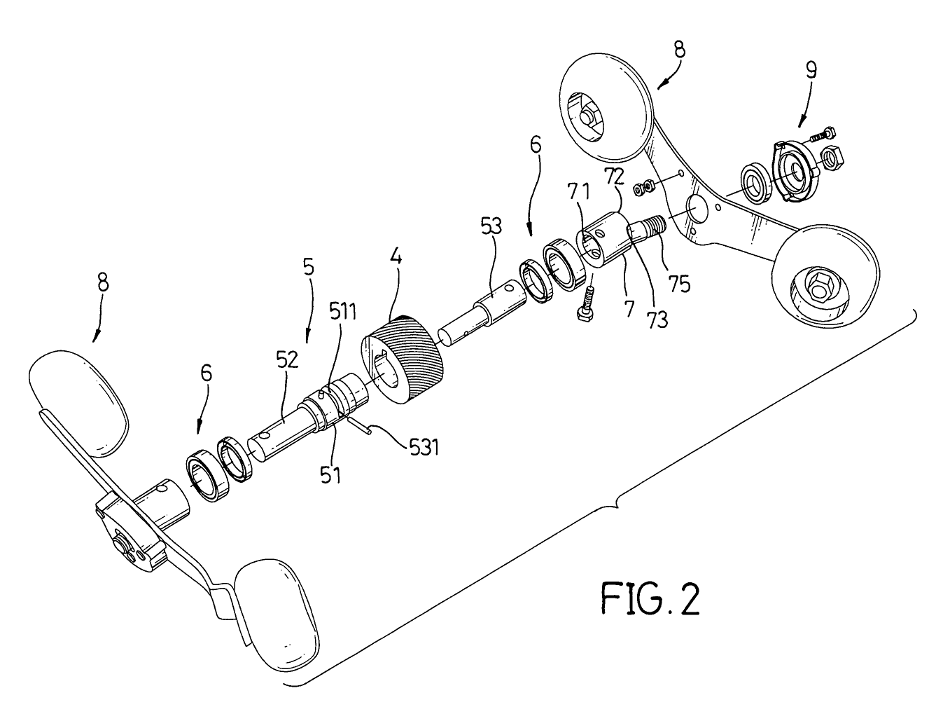

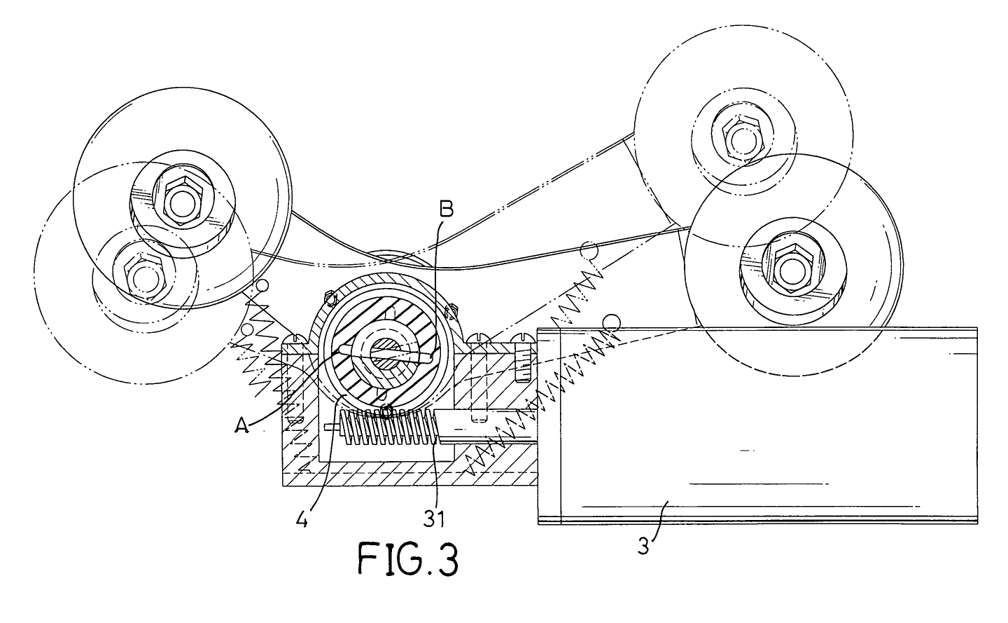

With reference to FIGS. 2 and 3, it is noted that the motor (3) has a motor shaft (31) extending from the motor (3) to mate with a gear (4) such that when the motor shaft (31) rotates, the gear (4) is driven to rotate. The gear (4) is hollow inside and has two opposite ends. A transmission shaft (5) in accordance with the present invention includes a hollow cylindrical casing (51) securely received in the gear (4), a stationary arm (52) integrally formed and extending out of the cylindrical casing (51) and a rotation arm (53) having a first end rotatably received in the other open end of the cylindrical casing (51) and a second end extending away from the cylindrical casing (51). The cylindrical casing (51) has a cutout (511) defined through an outer periphery of the cylindrical casing (51) to receive therein a pin (531) which is extended into an end of the rotation arm (53). A respective free end of the stationary arm (52) and the rotation arm (53) is connected to a bearing (6), a sleeve (7) and a stick (8). The sleeve (7) is hollow inside and has an open end (71) and a closed end (72) so that free ends of the stationary arm (52) and the rotation arm (53) as well as the bearings (6) are respectively received in the open ends of the respective sleeves (7). The closed end (72) of the sleeve (7) is provided with an inclined face (73) and an extension (75) extending from a bottom of the inclined face (73) to extend through a stick (8) for connection with a securing device (9) such as nuts or the like.

From the previous description, it is noted that because the stationary arm (52) is integrally formed with the cylindrical casing (51) and one end of the rotation arm (53) is rotatably received in the cylindrical casing (51) but with the pin (531) movably received in the cutout (511), when the cylindrical casing (51) is rotated due to a rotation of the gear (4) from the result of the rotation of the motor shaft (531), the stationary arm (52) is simultaneously driven by the cylindrical casing (51) to rotate. However, the rotation arm (53) will not be rotated unless the pin (531) is abutted a bottom face defining the cutout (511).

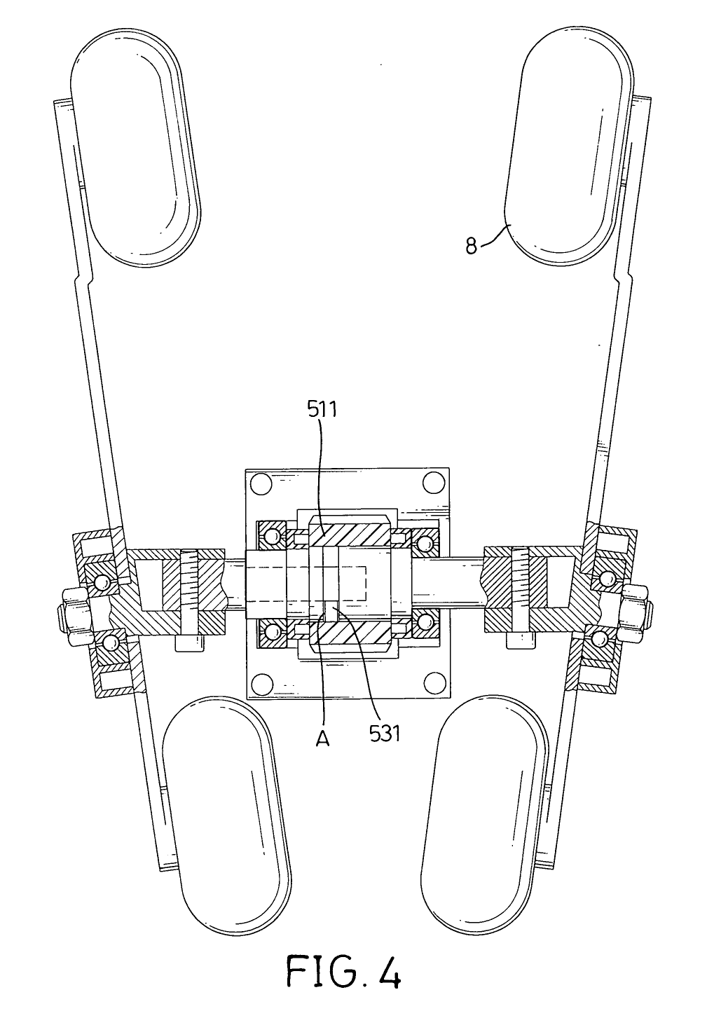

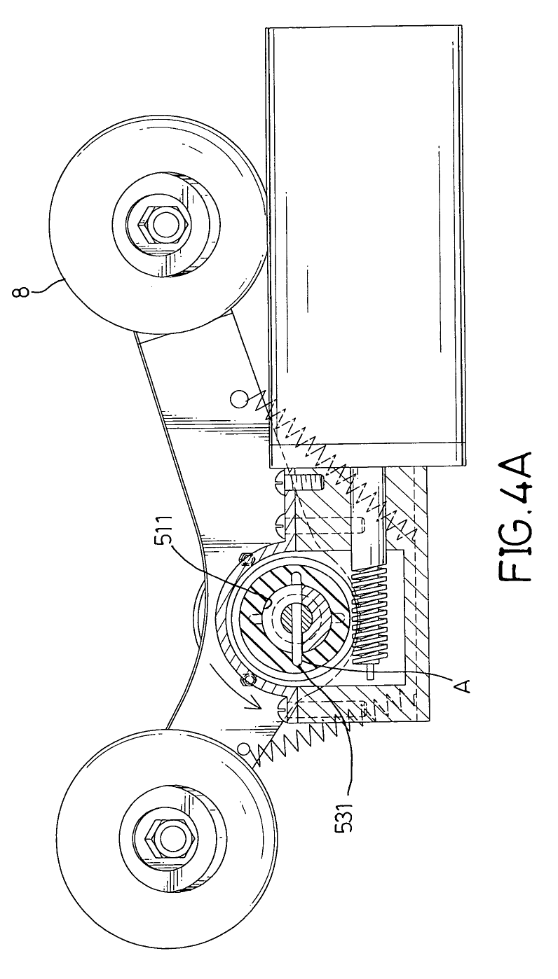

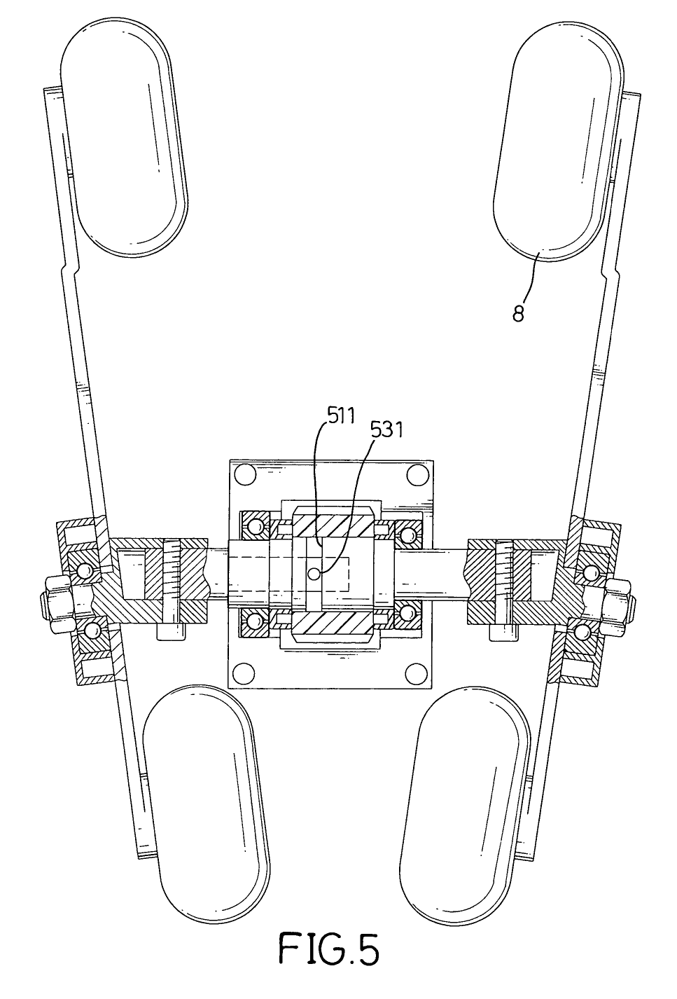

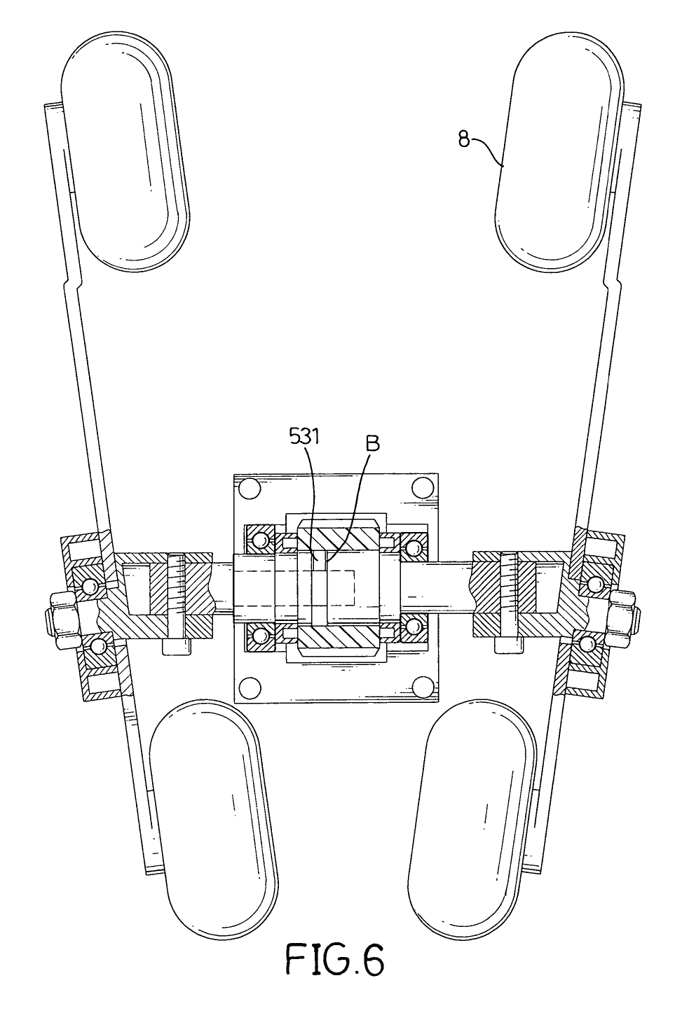

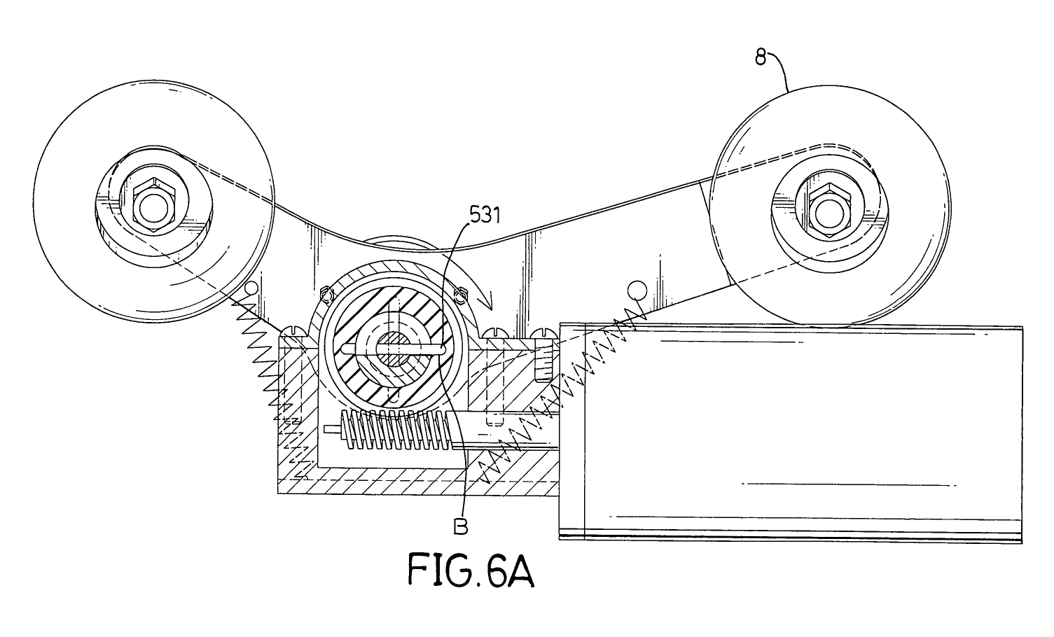

For a better understanding of the operation of the transmission shaft (5) of the present invention, with reference to FIGS. 4, 4A, 5, 6 and 6A, the cutout (511) has two dead points, a first dead point A and a second dead point B. That is, the cutout (511) is defined to have a slender configuration and the first dead point A is located at a first bottom end face defining the cutout (511) and the second dead point B is located at a second bottom end face defining the cutout (511). Therefore, when the motor (3) is rotated is clockwise direction, the cylindrical casing (51) is driven to rotate in a first direction. Because the stationary arm (52) is integrally formed with the cylindrical casing (51), the stationary arm (52) is rotated simultaneously. At the same time, if the pin (531) is located at the first dead point A, the two sticks (8) are thus moved simultaneously and a kneading effect is provided to the user. However, if the motor (3) is rotating from clockwise to counterclockwise during the kneading process, the stationary arm (52) is remained simultaneous rotational movement with the cylindrical casing (51). However, at the time the motor (3) reverses its rotational direction, the pin (531) is moving from the first dead point A toward the second dead point B. During the movement from the first dead point A toward the second dead point B, the rotation arm (53) is not rotated with the cylindrical casing (51). When the pin (531) reaches the second dead point B, the rotation arm (53) is rotated with the cylindrical casing (51). Again, because the stationary arm (52) is rotated first and then the rotation arm (53) such that there is a phase difference between the stationary arm (52) and the rotation arm (53). Preferably, the phase difference between the stationary arm (52) and the rotation arm (53) is 180 degrees. With the preferred phase difference between the stationary arm (52) and the rotation arm (53), the two sticks (8) are moved differently so as to provide a pounding effect. Therefore, the 180-degree phase difference between the two sticks (8) results in obvious pounding effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transmission shaft for a massager having two opposite sticks operably connected to a transmission axle which is driven by a motor, the transmission shaft comprising:
a hollow cylindrical casing with two open ends and a cutout defined through an outer periphery of the cylindrical casing;
a stationary arm a proximate end thereof is integrally formed with the cylindrical casing and a distal end thereof is extended away from the cylindrical casing for connection with one of the two sticks;
a rotation arm a proximate end thereof is rotatably received in the cylindrical casing and a distal end thereof is extended away from the cylindrical casing for connection with the other one of the two sticks; and
a pin movably received in the cutout and securely extended into a periphery of the proximate end of the rotation arm such that a rotational direction change of the motor is able to cause a phase difference between the stationary arm and the rotation arm and thus the two sticks are able to change from providing kneading effect to pounding effect.

2. The transmission shaft as claimed in claim 1, wherein a bearing is provided to distal ends of the stationary arm and the rotation arm.

3. The transmission shaft as claimed in claim 2, wherein a sleeve is provided to receive therein the bearing of the respective stationary arm and the rotation arm, the sleeve has an open end defined to receive therein the bearing and a closed end provided with an inclined face.

4. The transmission shaft as claimed in claim 3, wherein an extension is extended from a bottom of the inclined face for secure connection with the stick.

5. A transmission shaft for a massager having two opposite sticks operably connected to a transmission axle which is driven by a motor, the transmission shaft comprising:
a hollow cylindrical casing with two open ends and a cutout defined through an outer periphery of the cylindrical casing;
a stationary arm a proximate end thereof is integrally formed with the cylindrical casing and a distal end thereof is extended away from the cylindrical casing for connection with one of the two sticks;
a rotation arm a proximate end thereof is rotatably received in the cylindrical casing and a distal end thereof is extended away from the cylindrical casing for connection with the other one of the two sticks; and
a pin movably received in the cutout and securely extended into a periphery of the proximate end of the rotation arm, the pin being reciprocal movable from a first position to a second position when the motor rotational direction changes such that the two sticks are able to change from providing kneading effect to providing pounding effect, wherein a bearing is provided to distal ends of the stationary arm and the rotation arm.

6. The transmission shaft as claimed in claim 5, wherein a sleeve is provided to receive therein the bearing of the respective stationary arm and the rotation arm, the sleeve has an open end defined to receive therein the bearing and a closed end provided with an inclined face.

7. The transmission shaft as claimed in claim 6, wherein an extension is extended from a bottom of the inclined face for secure connection with the stick.
